(19) United States
(12) Patent Application Publication
(10) Pub. No.: US 2025/0269436 A1
(43) Pub. Date: Aug. 28, 2025

(54) INSERT HOLDER ASSEMBLY HAVING CUTTING INSERT INDEXING ARRANGEMENT, CUTTING TOOL AND METHOD FOR INDEXING

(71) Applicant: ISCAR, LTD., Tefen (IL)

(72) Inventor: GIL HECHT, NAHARIYA (IL)

(73) Assignee: ISCAR, LTD., Tefen (IL)

(21) Appl. No.: 18/589,627

(22) Filed: Feb. 28, 2024

(51) Int. Cl. B23B 27/16

(52) U.S. Cl. CPC B23B 27/16

(57) ABSTRACT

A cutting insert includes at least two peripheral cutting edges. An insert holder assembly includes an insert holder which include an insert pocket and an ejector chamber connected by a through hole. The insert holder assembly includes an ejector member located at least partially in the ejection chamber, and a compressible biasing member. In an inner position, the biasing member exerts a compressive force on the ejector member. When the cutting insert is releasably attached to the insert holder by a fastening member which is connected to the ejector member, to constitute a fastened position of a cutting tool, the insert holder assembly is in the inner position and the fastening member clamps the cutting insert so that the insert lower surface abuts the pocket base surface.

### FIELD OF THE INVENTION

The subject matter of the present application relates to cutting tools of the type in which a cutting insert is releasably retained in an insert receiving pocket of an insert holder, and in particular to such cutting tools having an indexing arrangement for indexing the cutting insert.

### BACKGROUND OF THE INVENTION

Cutting inserts can be releasably clamped in an insert receiving pocket of an insert holder by a mounting mechanism, such as a retaining screw. The cutting insert can have at least two cutting edges. One of the cutting edges forms an active cutting edge, ready for performing metal cutting operations. The other cutting edge(s) form non-active cutting edge(s). The cutting insert can be seated in the insert receiving pocket in more than one indexable position in order to exchange the active cutting edge with one of the non-active cutting edges, when the active cutting edge is worn or damaged. Stated differently, some such cutting tools can include an indexing arrangement which adjusts the cutting insert from one indexable position to another.

One example is disclosed in, for example, U.S. Pat. No. 4,326,437, where the cutting tool is pivotally mounted on the tool holder about a first pivot axis for pivotal indexing movement of the tool body relative to the tool holder to successively dispose a selected cutting edge in a predetermined cutting position relative to the tool holder.

Another example is disclosed in U.S. Pat. No. 9,981,324, where the cutting inserts can be replaced fast and easily, and possibly also be indexed by an ejection mechanism. Components of this mechanism comprise a pair of generally cylindrical sleeves. Between these sleeves, there acts a compressible force generator in the form of a simple, mechanical compression spring.

### SUMMARY OF THE INVENTION

In accordance with a first aspect of the subject matter of the present application there is provided an insert holder assembly comprising:
an insert holder comprising:
   opposite pocket and non-pocket holder side surfaces;
   an insert receiving pocket, having a pocket indexing axis defining a biasing direction, the insert receiving pocket being recessed in the pocket holder side surface and comprising a pocket base surface oriented transversely to the pocket indexing axis;
   an ejection chamber being forward from the insert receiving pocket in the biasing direction, the ejection chamber comprising a chamber abutment surface and a chamber compression surface; and
   a holder through hole connecting the ejection chamber and the insert receiving pocket, the holder through hole extending along the pocket indexing axis;
an ejector member located in the ejection chamber, the ejector member comprising an ejector abutment surface and an ejector compression surface;
an elastically compressible biasing member elastically compressed between the ejector compression surface and the ejection chamber compression surface; wherein:
   the insert holder assembly is adjustable between an inner position and an outer position;
   in the inner position:
      the ejector abutment surface abuts the chamber abutment surface;
      the ejector compression surface is spaced apart from the chamber compression surface by an inner distance; and
      the biasing member exerts an inner compressive force on the ejector member; and
   in the outer position:
      the ejector abutment surface is spaced apart from the chamber abutment surface;
      the ejector compression surface is spaced apart from the chamber compression surface by an outer distance, the outer distance being greater than the inner distance; and
   the biasing member exerts an outer compressive force on the ejector member.

In accordance with a second aspect of the subject matter of the present application there is provided a cutting tool comprising:
an insert holder assembly of the type described above;
a cutting insert comprising an insert lower surface and two circumferentially spaced apart cutting edges, the cutting insert releasably retained in the insert receiving pocket; and
a fastening member passing through the holder through hole and being attached to the ejector member; wherein:
   the cutting tool is adjustable between a fastened position and a released position; and
      in the fastened position:
         the insert holder assembly is in the inner position; and
         the fastening member rigidly clamps the cutting insert with the insert lower surface abutting the pocket base surface;
      in the released position:
         the insert holder assembly is in the outer position; and
         the fastening member clamps the cutting insert with the insert lower surface abutting the pocket base surface, by virtue of the fastening member being urged in the biasing direction by the outer compressive force applied on the ejector member by the biasing member being elastically compressed.

In accordance with a third aspect of the subject matter of the present application there is provided a method for adjusting a cutting tool from a fastened position to a second fastened position; wherein:
the cutting tool is of the type described above;
the cutting tool is in the fastened position; and
the method includes the steps of:
   unfastening the fastening member so that the cutting tool is in the released position;
   rotating the cutting insert in the rotational indexing position so that the that the cutting tool is in the intermediate position;
   further rotating the cutting insert in the rotational indexing position so that the that the cutting tool is in a second released position; and fastening the fastening member so that the cutting tool is in a second fastened position.

It is understood that the above-said is a summary, and that features described hereinafter may be applicable in any combination to the subject matter of the present application, for example, any of the following features may be applicable to the insert holder assembly or cutting tool:

The insert holder can comprise a holder end surface connecting the pocket and non-pocket holder side surfaces and a stopper recess recessed in the holder end surface and opening out to the ejection chamber. The insert holder assembly can comprise a stopper member releasably attached to the insert holder, the stopper member being located in a stopper recess and projecting into the ejection chamber. The insert holder assembly can be further adjustable to a stop position from the outer position. In the stop position, the stopper member can prevent the ejector member from moving in the biasing direction. The ejector compression surface can be spaced apart from the chamber compression surface by a stop distance, the stop distance being greater than the outer distance. The biasing member can exert a stop compressive force on the ejector member.

The ejector member can comprise an ejector recess recessed in the ejector peripheral surface. In the stop position, the stopper member can prevent the ejector member from moving in the biasing direction by being located in the ejector recess and being in contact therewith.

The ejector member can comprise first and second ejector end surfaces and an ejector peripheral surface extending therebetween about an ejector central axis. The ejector member can comprise a threaded bore which opens out to first ejector end surface.

The ejector abutment surface can be located on the ejector end surface.

The ejector peripheral surface can comprise an ejector shoulder surface oriented transversely to the ejector central axis. The ejector compression surface can be located on the ejector shoulder surface.

The biasing member can be a helical spring.

The holder through hole can open out to the pocket base surface.

The ejection chamber can comprise a chamber bottom surface. The holder through hole can open out to the chamber bottom surface.

The chamber abutment surface can be formed on the chamber bottom surface.

The chamber compression surface can be formed on the chamber bottom surface.

The ejection chamber can be recessed in the non-pocket holder side surface.

The insert receiving pocket can comprise a pocket peripheral surface oriented transversely to pocket indexing axis and forming a partial boundary of the pocket base surface. In a view along the pocket indexing axis, the pocket peripheral surface can define part of an imaginary pocket circle having a center contained in the pocket indexing axis.

The pocket base surface can comprise a plurality of pocket engagement members, the plurality of pocket engagement members comprising a plurality of male-type engagement members or a plurality of female-type engagement members.

The plurality of pocket engagement members can comprise the plurality of male-type engagement members.

Each pocket engagement member can be elongated along a pocket engagement member axis, each pocket engagement member can comprise two diverging pocket member flank surfaces comprising a first pocket member flank surface and a second pocket member flank surface which both extend along the pocket engagement member axis.

The insert receiving pocket has a pocket base plane oriented perpendicular to pocket indexing axis and intersecting the pocket base surface. For any given pocket engagement member, in a cross-sectional view taken in a plane oriented perpendicular to the pocket engagement member axis: An outer portion of the first pocket member flank surface can slope at a first pocket flank angle with respect to the pocket base plane. The second pocket member flank surface can slope at a second pocket flank angle with respect to the pocket base plane. The first pocket flank angle can be less than the second pocket flank angle.

A fastening member can pass through the holder through hole and can be attached to the ejector member.

The ejector member can comprise a threaded bore. The cutting insert can comprise an insert through hole. The fastening member can be a clamping screw threadingly engaged with the threaded bore and located in the insert through hole thereby clampingly engaging the cutting insert.

The cutting tool can be further adjustable to an intermediate position from the released position. In the intermediate position: The insert holder assembly can be in the outer position. The cutting insert can be rotated in a rotational indexing direction about the pocket indexing axis from the released position.

The pocket base surface can comprise a plurality of pocket engagement members. The insert lower surface can comprise a plurality of insert engagement members. One of the plurality of pocket engagement members and the plurality of insert engagement members can comprise a plurality of male-type engagement members and the other one of the plurality of pocket engagement members and the plurality of insert engagement members can comprise a plurality of female-type engagement member. In fastened position of the cutting tool, the male-type and female-type engagement members can inter-engage with each other.

The plurality of pocket engagement members can comprise the plurality of male-type engagement members. The plurality of insert engagement members can comprise the plurality of female-type engagement members.

The cutting insert can comprise insert upper and lower surfaces and an insert peripheral surface extending therebetween, the insert peripheral surface extending about an insert central axis. In a view along the insert central axis, the at least two cutting edges can define an imaginary circumscribed insert circle having a center contained in the insert central axis. In a view along the pocket indexing axis, the pocket peripheral surface can define an imaginary pocket circle having a center contained in the pocket indexing axis. In the fastened position of the cutting tool, in a view along the pocket indexing axis, the imaginary circumscribed insert circle can be contained within the imaginary pocket circle.

### BRIEF DESCRIPTION OF THE FIGURES

For a better understanding of the present application and to show how the same may be carried out in practice, reference will now be made to the accompanying drawings, in which:

FIG. 1 is a perspective view of an insert receiving pocket and a cutting insert of a cutting tool, in accordance with the present invention;

FIG. 2 is an exploded view of FIG. 1;

FIG. 3 is another exploded perspective view of the cutting tool shown in FIG. 1;

FIG. 4 is a bottom view of the cutting insert shown in FIG. 1;

FIG. 5 is a side view of an insert holder assembly, in an inner position, shown in FIG. 1, in front of the insert receiving pocket;

FIG. 6 is a cross-sectional view of the insert receiving pocket, taken along the line VI-VI in FIG. 5, through two adjacent pocket engagement members;

FIG. 7 is a side view of the cutting tool, in a fastened position, shown in FIG. 1, in front of the insert receiving pocket;

FIG. 8 is a fragmentary cross-sectional view of the cutting tool, taken along the line VIII-VIII in FIG. 7;

FIG. 8A is detail of FIG. 8;

FIG. 8B is an analogous cross-sectional view shown in FIG. 6 of the cutting tool in the fastened position;

FIG. 9 is an analogous cross-sectional view shown in FIG. 8 of the cutting tool in a released position;

FIG. 10 is an analogous cross-sectional view shown in FIG. 8 of the cutting tool in another released position;

FIG. 11 is a side view of the cutting tool, in an intermediate position, in front of the insert receiving pocket, with the cutting insert rotated; and

FIG. 12 is a fragmentary cross-sectional view of the cutting tool, taken along the line XII-XII in FIG. 11.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

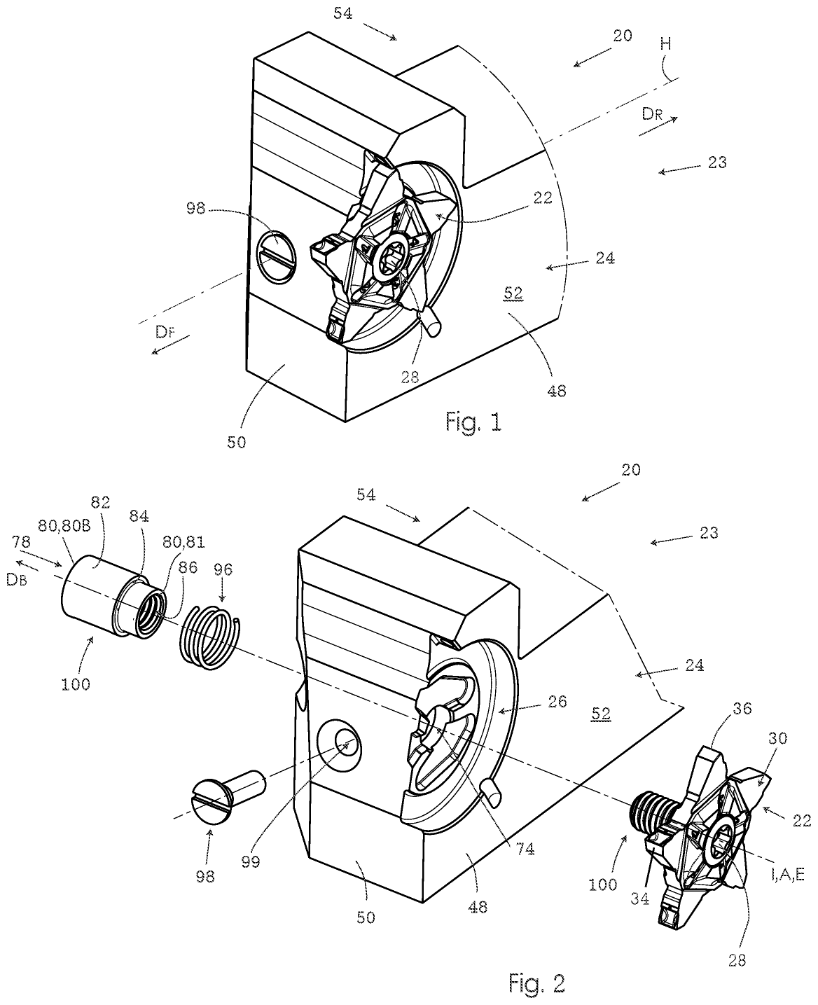

Attention is first drawn to FIGS. 1 to 3 showing a cutting tool 20, for chip removal, in accordance with embodiments of the subject matter of the present application. The cutting tool 20 has a cutting insert 22 which can be typically made from cemented carbide or ceramic. The cutting tool 20 also has an insert holder assembly 23. The insert holder assembly 23 has an insert holder 24 having an insert receiving pocket 26. The insert holder 24 can be typically made from steel. In this non-limiting example, the cutting tool 20 is a non-rotary grooving tool and the cutting insert 22 is a grooving insert. It is noted, however, that the subject matter of the present application also applies to other types of cutting tools and cutting inserts, for example, but not limited to, turning tools and turning inserts. The cutting tool 20 is adjustable between a released and fastened position. In the fastened position of the cutting tool 20, the cutting insert 22 is releasably attached to the insert holder assembly 23 by a fastening member 28 which clamps the cutting insert 22 in the insert receiving pocket 26. In such a position, the cutting tool 20 is ready for cutting operations on a workpiece.

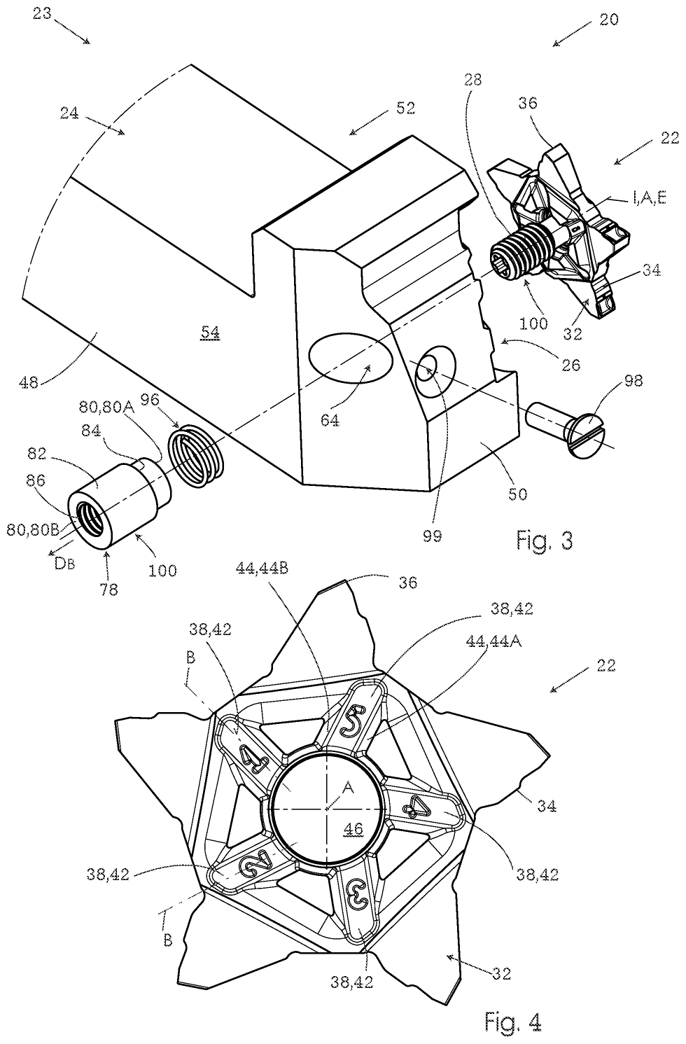

Reference is now made to FIG. 4, showing the cutting insert 22, in accordance with the subject matter of the present application, relating to a first aspect of the invention. The cutting insert 22 has a unitary integral one-piece construction. The cutting insert 22 has an insert central axis A. As seen in FIGS. 2 and 3, the cutting insert 22 includes opposing insert upper and lower surfaces 30, 32 and an insert peripheral surface 34 that extends between the insert upper and lower surfaces 30, 32. The insert peripheral surface 34 extends circumferentially about the insert central axis A. The insert central axis A defines a thickness direction of the cutting insert 22. The insert central axis A extends through the insert upper and lower surfaces 30, 32.

In accordance with some embodiments of the subject matter of the present application, the cutting insert 22 can include an insert through hole 46 which opens out to the insert upper and lower surfaces 30, 32, for accommodating a fastening member, such as a retaining screw (as further discussed later in the description). The insert through hole 46 can extend along the insert central axis A.

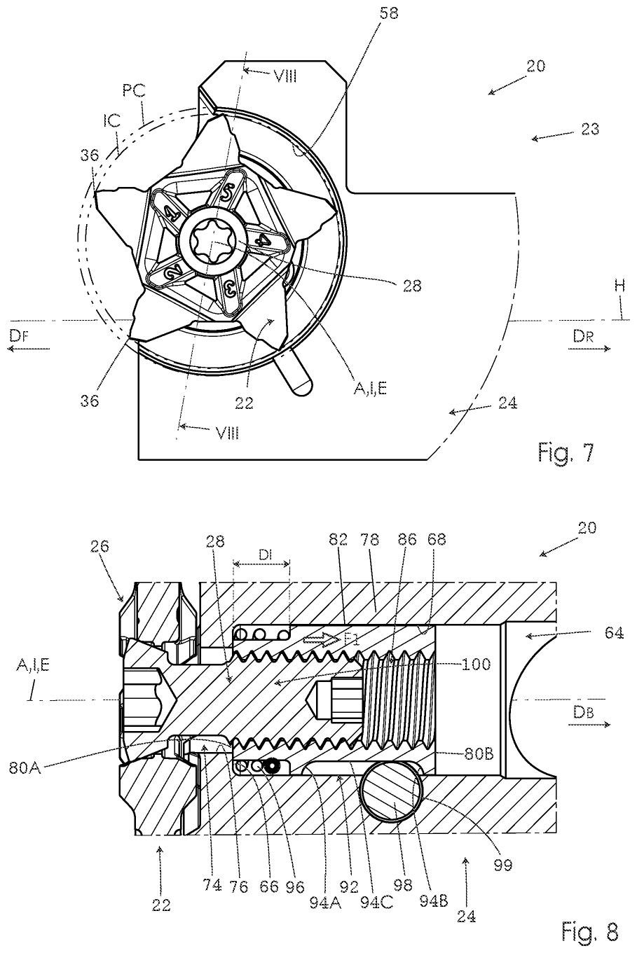

The cutting insert 22 includes at least two circumferentially spaced apart cutting edges 36. In accordance with some embodiments of the subject matter of the present application, the at least two cutting edges 36 can be formed on the insert peripheral surface 34. It is noted that the at least two cutting edges 36 extend in the thickness direction of the cutting insert 22. The at least two cutting edges 36 can extend between the insert upper and lower surfaces 30, 32. In a view along the insert central axis A (see FIG. 7), the at least two cutting edges 36 define an imaginary circumscribed insert circle IC having a center contained in the insert central axis A.

Reverting to FIG. 4, in accordance with some embodiments of the subject matter of the present application, the insert lower surface 32 can include a plurality of insert engagement members 38. The insert engagement members 38 serve to engage with complementary engagement members in the insert receiving pocket 26 when the cutting tool 20 is in the fastened position. The plurality of insert engagement members 38 can include a plurality of male-type engagement members 40 (not shown) or a plurality of female-type engagement members 42. Preferably, the plurality of insert engagement members 38 include the plurality of female-type engagement members 42.

In accordance with some embodiments of the subject matter of the present application, each insert engagement member 38 can be elongated along an insert engagement member axis B, forming ribs or slots. Generally speaking, the insert engagement member axis B extends radially. Each insert engagement member 38 can include two diverging insert member flank surfaces 44. The two diverging insert member flank surfaces 44 include a first insert member flank surface 44A and a second insert member flank surface 44B. The first insert member flank surface 44A and the second insert member flank surface 44B both extend along a respective insert engagement member axis B. Specifically, the first insert member flank surface 44A and the second insert member flank surface 44B both extend along opposite elongated sides of a male-type engagement member 40 or a female-type engagement member 42. The male-type engagement members 40 can have the form of protruding elongated ridges. The female-type engagement members 42 can have the form of recessed elongated grooves.

A second aspect of the subject matter of the present application relates to the insert holder assembly 23. Attention is drawn to FIGS. 1-3, 5 to 10. Referring to FIG. 1-3, the insert holder 24 of the insert holder assembly 23 has a holder longitudinal axis H which defines opposite forward and rearward directions D_{F}, D_{R}. The insert holder 24 includes a holder main surface 48 that intersects a holder end surface 50. The holder main surface 48 extends circumferentially about the holder longitudinal axis H. The holder end surface 50 is intersected by the holder longitudinal axis H and faces generally in the forward direction D_{F}. The holder main surface 48 includes opposite pocket and non-pocket holder side surfaces 52, 54. The holder end surface 50 extends between (and here connects) the pocket and non-pocket holder side surfaces 52, 54.

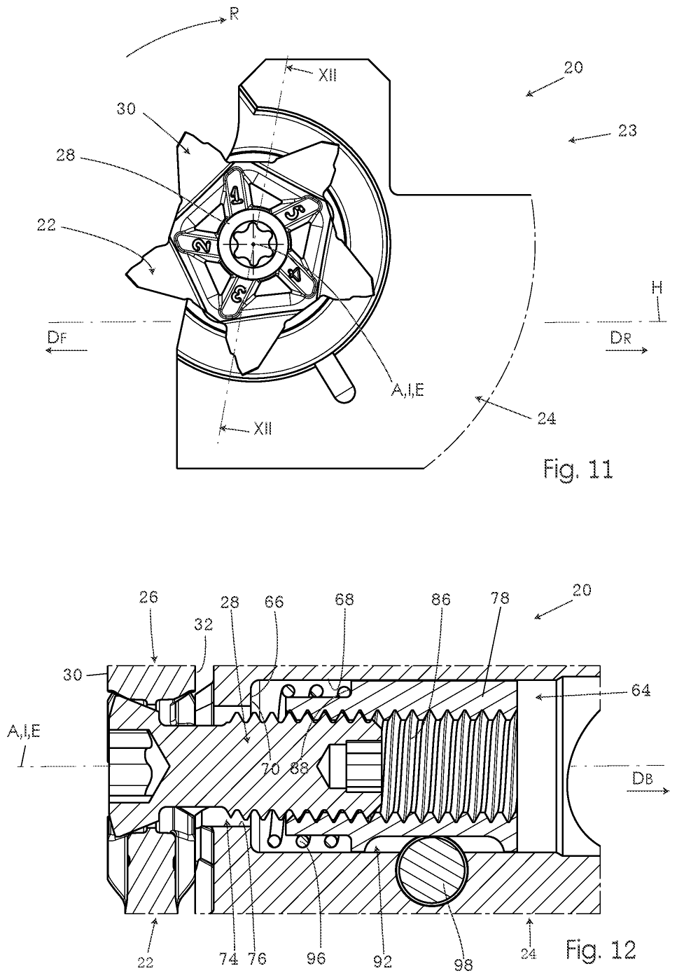

It should be noted that use of the terms “forward” and “rearward” throughout the description and claims refer to a relative position in a direction of the tool holder longitudinal axis H towards the left and right, respectively, in FIGS. 7 and 11. Generally speaking, the forward direction D_{F} is the direction towards the cutting insert 22.

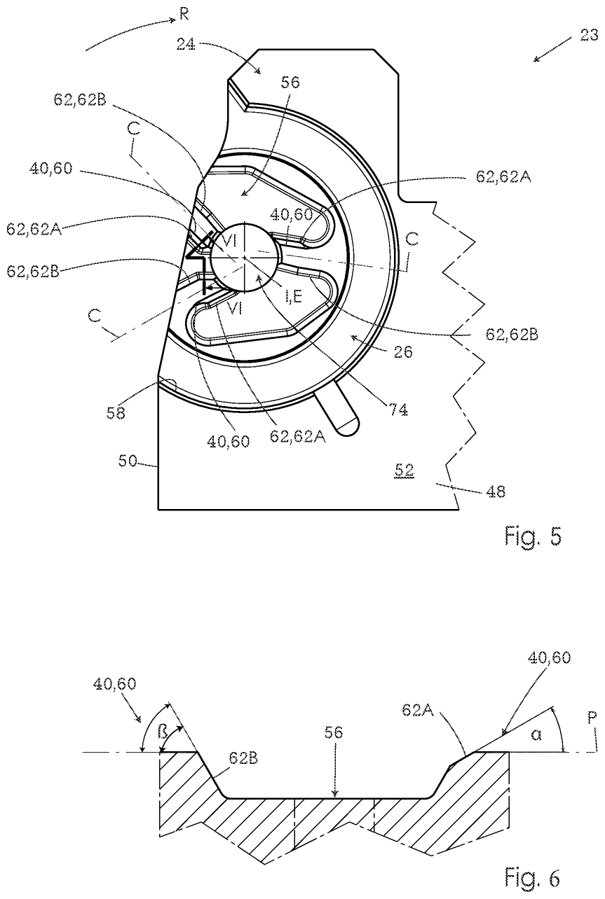

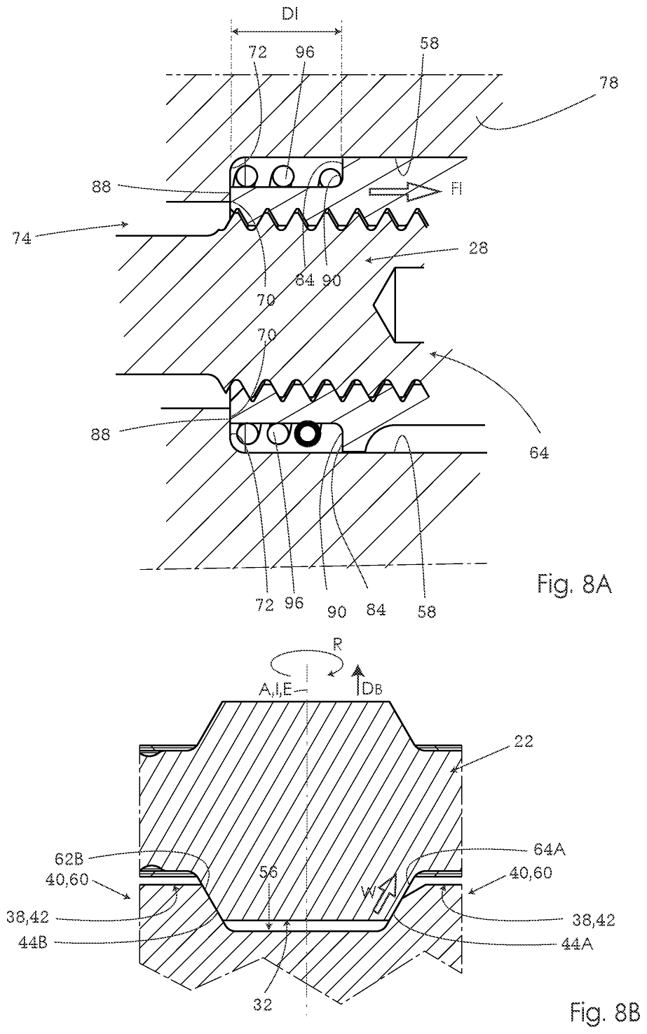

Referring to FIG. 5, the insert receiving pocket 26 is located at a forward end of the insert holder 24. The insert receiving pocket 26 is recessed in the pocket holder side surface 52. The insert receiving pocket 26 opens out to the holder end surface 50 which allows the active cutting edge 36 to protrude beyond the holder end surface 50 and access the workpiece. Making reference to FIG. 8, the insert receiving pocket 26 has a pocket indexing axis I which defines a biasing direction D_{B}.

Reverting to FIG. 5, the insert receiving pocket 26 includes a pocket base surface 56. The pocket base surface 56 is oriented transversely to the pocket indexing axis I. As seen in FIG. 6, the insert receiving pocket 26 has a pocket base plane P oriented perpendicular to pocket indexing axis I which intersects the pocket base surface 56. The insert receiving pocket 26 includes a pocket peripheral surface 58. The pocket peripheral surface 58 is oriented parallel or substantially parallel to the pocket indexing axis I (the former being preferable) and forms a partial boundary of the pocket base surface 56. The pocket peripheral surface 58 extends partly about the pocket indexing axis I. Referring to FIG. 7, in accordance with some embodiments of the subject matter of the present application, in a view along the pocket indexing axis I, the pocket peripheral surface 58 can define an imaginary pocket circle PC having a center contained in the pocket indexing axis I. The pocket peripheral surface 58 can lie on an imaginary cylinder defined by the imaginary pocket circle PC.

Referring to FIG. 5, in accordance with some embodiments of the subject matter of the present application, the pocket base surface 56 can include a plurality of pocket engagement members 60. The plurality of pocket engagement members 60 can include a plurality of male-type engagement members 40 or a plurality of female-type engagement members 42 (not shown). Preferably, the plurality of pocket engagement members 60 include the plurality of male-type engagement members 40. The number of pocket engagement members 60 may or may not be the same as the number of insert engagement members 38. In this non-limiting example shown in the drawings, the cutting insert 22 has five insert engagement members 38 and the insert receiving pocket 26 has three pocket engagement members 60.

It is noted that in order so that the insert and pocket engagement member 38, 60 can engage with each other, one of the plurality of pocket engagement members 60 and the plurality of insert engagement members 38 includes a plurality of male-type engagement members 40 and the other one of the plurality of pocket engagement members 60 and the plurality of insert engagement members 38 includes a plurality of female-type engagement members 42.

In accordance with some embodiments of the subject matter of the present application, each pocket engagement member 60 can be elongated along a pocket engagement member axis C, forming ribs or slots. Generally speaking, the pocket engagement member axis C extends radially. Each pocket engagement member 60 can include two diverging pocket member flank surfaces 62. The two diverging pocket member flank surfaces 62 include a first pocket member flank surface 62A and a second pocket member flank surface 62B. The first pocket member flank surface 62A and the second pocket member flank surface 62B both extend along a respective pocket engagement member axis C. Specifically, the first pocket member flank surface 62A and the second pocket member flank surface 62B both extend along opposite elongated sides of a male-type engagement member 40 or a female-type engagement member 42. Similar to the insert engagement members 38, the male-type engagement members 40 can have the form of protruding elongated ridges. The female-type engagement members 42 can have the form of recessed elongated grooves. The first pocket member flank surface 62A is ahead of the second pocket member flank surface 62B in a rotational indexing direction R about the pocket indexing axis I. The rotational indexing direction R may be clockwise in a side-view onto the insert receiving pocket 26 (see FIG. 11).

Making reference to FIG. 6, in accordance with some embodiments of the subject matter of the present application, for any given pocket engagement member 60, in a cross-sectional view taken in a plane oriented perpendicular to the pocket engagement member axis C, an outer portion of the first pocket member flank surface 62A (i.e. the part furthest from the second pocket member flank surface 62B) can be chamfered. The (chamfered) outer portion of the first pocket member flank surface 62A can slope at a first pocket flank angle α with respect to the pocket base plane P. The second pocket member flank surface 62B can slope at a second pocket flank angle β with respect to the pocket base plane P. The first pocket flank angle α can be less than the second pocket flank angle β so that rotating the cutting insert 22 is easier in the rotational indexing direction R.

Reference is now made to FIG. 8, showing a cross-section in a transverse plane (in this case, oriented slantingly, i.e. non-perpendicularly, to the holder longitudinal axis H) of the insert holder assembly 23 in the inner position (and the cutting tool 20 in the fastened position). The insert holder 24 includes an ejection chamber 64. The ejection chamber 64 is forward from the insert receiving pocket 26 in the biasing direction D_{B}. In accordance with some embodiments of the subject matter of the present application, the ejection chamber 64 can be recessed in the non-pocket holder side surface 54. The ejection chamber 64 can include a chamber bottom surface 66 and a chamber wall surface 68 which intersects, and forms a boundary of, the chamber bottom surface 66. The chamber wall surface 68 extends about the pocket indexing axis I. The chamber wall surface 68 intersects the non-pocket holder side surface 54. The chamber bottom surface 66 can be planar. The chamber bottom surface 66 can be oriented perpendicular to the pocket indexing axis I.

Making reference to FIG. 8A, the ejection chamber 64 includes a chamber abutment surface 70 and a chamber compression surface 72 for contact with corresponding surfaces on an ejector member and a biasing member (further described later in the description), respectively. In accordance with some embodiments of the subject matter of the present application, the chamber abutment surface 70 can be formed on the chamber bottom surface 66. Likewise, the chamber compression surface 72 can be formed on the chamber bottom surface 66. Thus, the chamber abutment surface 70 and the chamber compression surface 72 can be co-planar. The chamber abutment surface 70 can be radially inward from the chamber compression surface 72.

Reverting to FIG. 8, the insert holder 24 includes a holder through hole 74 which connects the ejection chamber 64 and the insert receiving pocket 26. The holder through hole 74 extends along the pocket indexing axis I. The holder through hole 74 includes a through hole peripheral surface 76 which extends about the pocket indexing axis I. In accordance with some embodiments of the subject matter of the present application, the holder through hole 74 can open out to the pocket base surface 56. The holder through hole 74 can open out to the chamber bottom surface 66.

Referring to FIGS. 2 and 3, the insert holder assembly 23 includes an ejector member 78. The ejector member 78 includes two ejector end surfaces 80 and an ejector peripheral surface 82 which extends therebetween. The two ejector end surfaces 80 include a first ejector end surface 80A and second ejector end surface 80B. The ejector peripheral surface 82 extends about an ejector central axis E. The ejector member 78 is located in the ejection chamber 64.

In accordance with some embodiments of the subject matter of the present application, the ejector member 78 can be elongated with the two ejector end surfaces 80 located at opposite longitudinal ends thereof.

In accordance with some embodiments of the subject matter of the present application, the ejector member 78 can include a threaded bore 86 which opens out to the first ejector end surface 80A. The threaded bore 86 can extend along the ejector central axis E. The threaded bore 86 can open out to the second ejector end surface 80B to form a through bore. The ejector member 78 can have a basic configuration of a nut.

In accordance with some embodiments of the subject matter of the present application, the ejector peripheral surface 82 can include an ejector shoulder surface 84. The ejector shoulder surface 84 faces towards the first ejector end surface 80A. The ejector shoulder surface 84 is oriented transversely to the ejector central axis E. Preferably, the ejector shoulder surface 84 can be oriented perpendicular to the ejector central axis E.

The ejector member 78 includes an ejector abutment surface 88 and an ejector compression surface 90, for contact with corresponding surfaces on the ejection chamber 64 and a biasing member (further described later in the description), respectively. In accordance with some embodiments of the subject matter of the present application, the ejector abutment surface 88 can be located on the first ejector end surface 80A (stated differently, the ejector abutment surface 88 can be part of the first ejector end surface 80A). The ejector compression surface 90 can be located on the ejector shoulder surface 84 (stated differently, the ejector compression surface 90 can be part of the ejector shoulder surface 84).

Referring to FIG. 8, in accordance with some embodiments of the subject matter of the present application, the ejector member 78 can include an ejector recess 92 for accommodating a stopping member (as further described later in the description). The ejector recess 92 can be recessed in the ejector peripheral surface 82. The ejector recess 92 can include opposite diverging first and second recess end surfaces 94A, 94B. The ejector recess 92 can include a central recess base surface 94C which extends between the first and second recess end surfaces 94A, 94B. The first recess end surface 94A is closer to the first ejector end surface 80A than the second recess end surface 94B. In accordance with some embodiments of the subject matter of the present application, the ejector recess 92 can be in the form of a circumferential cutout groove defined laterally by the first and second recess end surfaces 94A, 94B. The circumferential groove can extend perpendicular to the ejector central axis E.

The insert holder assembly 23 includes an elastically compressible biasing member 96. The compressible biasing member 96 is elastically compressed between the ejector compression surface 90 and the chamber compression surface 72. Thus, the biasing member 96 exerts a compressive force on the ejector member 78. The compressive force on the ejector member 78 acts in the direction D_{B}, urging the ejector member 78 in the direction D_{B}. It is understood that a compressive force is one greater than zero. In accordance with some embodiments of the subject matter of the present application, the biasing member 96 can be a helical spring.

In accordance with some embodiments of the subject matter of the present application, the insert holder 24 can include a stopper recess 99 recessed in the holder end surface 50. The stopper recess 99 can open out to the ejection chamber 64. The insert holder assembly 23 can include a stopper member 98 releasably attached to the insert holder 24. The stopper member 98 and the stopper recess 99 can both be threaded, with the stopper member 98 threadingly engaged with the stopper recess 99. The stopper member 98 can be located in the stopper recess 99 and project into the ejection chamber 64. The stopper member 98 is designed to stop the biasing member 96 at a predetermined position (as further described later in the description). It is noted that without the stopper member 98, the biasing member 96 urges the ejector member 78 in the biasing direction D_{B} until the biasing member 96 achieves an uncompressed state (i.e., where it does not exert a compressive force on the ejector member 78).

The insert holder assembly 23 is adjustable between an inner position and an outer position.

Reference is now made to FIGS. 8 and FIG. 8A, showing a cross-section in a transverse plane of the insert holder assembly 23 in the inner position (and the cutting tool 20 in the fastened position). In the inner position of the insert holder assembly 23, the ejector abutment surface 88 abuts the chamber abutment surface 70. The ejector compression surface 90 is spaced apart from the chamber compression surface 72 by an inner distance DI. The biasing member 96 exerts an inner compressive force FI on the ejector member 78.

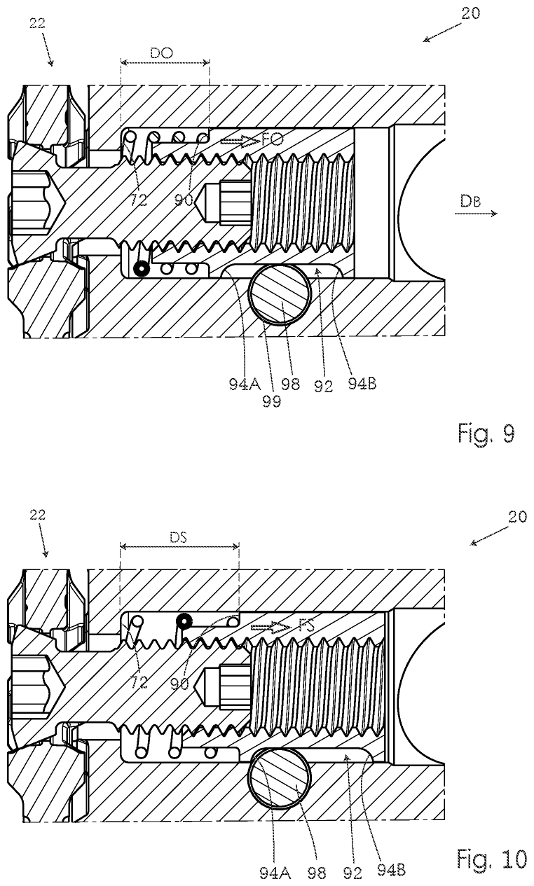

Reference is now made to FIG. 9, showing a cross-section in a transverse plane of the insert holder assembly 23 in the outer position (and the cutting tool 20 in the released position). In the outer position of the insert holder assembly 23 (i.e., FIG. 9), the ejector abutment surface 88 is spaced apart from the chamber abutment surface 70 by an outer distance DO. The biasing member 96 exerts an outer compressive force FO on the ejector member 78. The outer distance DO is greater than the inner distance DI. Thus, the outer compressive force FO is less than the inner compressive force FI (i.e. FO<FI).

In the configuration of the insert holder assembly 23 with the stopper member 98, in both the inner and outer positions of the insert holder assembly 23, the stopper member 98 does not impede the ejector member 78 (specifically, in the inner position the stopper member 98 is spaced apart from the second recess end surface 94B and in the outer position the stopper member 98 is spaced apart from the first recess end surface 94A).

In the configuration of the insert holder assembly 23 with the stopper member 98, the insert holder 24 can be further adjustable to a stop position from the outer position. Reference is now made to FIG. 10, showing a cross-section in a transverse plane of the insert holder assembly 23 in the outer position (and the cutting tool 20 in the another released position). In the stop position of the insert holder assembly 23, the stopper member 98 contacts and prevents the ejector member 78 from moving in the biasing direction D_{B}. That is to say, the ejector member 78 can be positioned in a predetermined position. In accordance with some embodiments of the subject matter of the present application the stopper member 98 can prevent the ejector member 78 from moving in the biasing direction D_{B} by being located in the ejector recess 92 and being in contact therewith. Specifically, the stopper member 98 can be in contact with the first recess end surface 94A.

In the stop position of the insert holder assembly 23, in accordance with some embodiments of the subject matter of the present application, the ejector compression surface 90 can be spaced apart from the chamber compression surface 72 by a stop distance DS. The biasing member 96 can exert a stop compressive force FS on the ejector member 78. The stop distance DS is greater than the outer distance DO. Thus, the stop compressive force FS is less than the outer compressive force FO (i.e. FS<FO<FI).

In accordance with some embodiments of the subject matter of the present application, it is appreciated that in the inner, outer and stopped positions of the insert holder assembly 23, the chamber wall surface 68 can abut the ejector peripheral surface 82, while allowing the ejector member 78 to slide within the chamber 64 when the insert holder assembly 23 is adjusted between positions.

Reference is now made additionally to FIGS. 11-12, showing the cutting tool 20, in accordance with the subject matter of the present application, relating to a third aspect of the invention. The cutting tool 20 includes a fastening member 28 which is attached to the ejector member 78. The fastening member 28 passes through (i.e., is located in) the holder through hole 74. The fastening member 28 and the ejector member 78 form a clamping member 100 (see FIGS. 2 and 3). The fastening member 28 is displaceable with respect to the ejector member 78, along the ejector central axis E. Thus, the clamping member 100 has a variable-length. In this non-limiting example shown in the drawings, the fastening member 28 can be a clamping screw threadingly engaged with the threaded bore 86 of the ejector member 76 and located in the insert through hole 46 (FIG. 4).

The seating and support of the cutting insert 22 in the insert receiving pocket 26 will be described with reference to FIGS. 1, 2 and 8 to 12. In this non-limiting example shown in the drawings, the clamping screw is tightened into the threaded bore 86. Referring to FIG. 8, in the fastened position of the cutting tool 20, the insert holder assembly 23 is in the inner position. The fastening member 28 rigidly clampingly engages the cutting insert 22. The insert lower surface 32 abuts the pocket base surface 56. It is noted that according to a preferred embodiment this abutment can occur only between the insert engagement members 38 and the pocket engagement members 60. The insert central axis A and the ejector central axis E are aligned with the pocket indexing axis I. In accordance with some embodiments of the subject matter of the present application, the male-type and female-type engagement members 40, 42 can engage with each other. Specifically, as seen in FIG. 8B, the first and second insert member flank surfaces 44A, 44B can abut the first and second pocket member flank surface 62A, 62B, respectively. The stopper member 98 may not be in contact with the ejector recess 92. Reverting to FIG. 7, in a view along the pocket indexing axis I, the imaginary circumscribed insert circle IC can be contained within the imaginary pocket circle PC, with the circumscribed insert circle IC and the pocket circle PC having the same center. Thus, the cutting insert 22 is rotatable about the pocket indexing axis I

To index the cutting insert 22 (i.e., adjust the cutting tool 20 from the fastened position to a second fastened position) the following steps are performed. The cutting tool 20 is firstly adjusted from the fastened position to the released position by unfastening the fastening member 28. In this non-limiting example shown in the drawings, this is achieved by partially untightening (loosening) the clamping screw 28 from the threaded bore 86.

Referring to FIG. 9, in the released position of the cutting tool 20, the insert holder assembly 23 is in the outer position. By virtue of the fastening member 28 being attached to the ejector member 78 and thus being urged in the biasing direction D_{B} by the outer compressive force FO applied on the ejector member 78 by the biasing member 96 being elastically compressed, the fastening member 28 clamps the cutting insert 22, with the insert lower surface 32 abutting the pocket base surface 56. In accordance with some embodiments of the subject matter of the present application, the male-type engagement members 40 can be located in the female-type engagement members 42.

It is noted that the fastening member 28 maintains sufficient clamping engagement with the cutting insert 22 so that the insert lower surface 32 maintains abutment with the pocket base surface 56. However, the outer compressive force FO is not of sufficient magnitude to securely fix the cutting insert 22 in the insert receiving pocket 26 so that the cutting tool 20 is ready for cutting a workpiece. That is to say, the cutting insert 22 is loosely clamped in the insert receiving pocket 26. When loosely clamped, the cutting insert 22 can be rotated in the rotational indexing direction R about the pocket indexing axis I to form an intermediate position of the cutting tool 20. Thus, the cutting insert 22 is in a different rotated position when in the intermediate position (see FIG. 11) compared to the fastened position (see FIG. 7). During rotation, the insert lower surface 32 slides over the pocket base surface 56.

It is recalled that in the outer position of the insert holder assembly 23, the ejector abutment surface 88 is spaced apart from the chamber abutment surface 70. In accordance with some embodiments of the subject matter of the present application, this allows the male-type and female-type engagement members 40, 42 to be free to disengage from each other during the rotation of the cutting insert 22. Referring to FIG. 8B, specifically, during rotation, the first insert member flank surfaces 44A can slide over the first pocket member flank surfaces 62A (in a direction indicated by arrow W), and the second insert member flank surfaces 44B separate from the second pocket member flank surfaces 62B, until the male-type engagement members 40 exit (i.e., are not located in) the female-type engagement members 42. During this process, by virtue of the sloping nature of the first insert member flank surfaces 44A and the first pocket member flank surfaces 62A, the cutting insert 22 is simultaneously displaced in a direction opposite the biasing direction D_{B}. This urges the clamping member 100 (i.e., the ejector member 78 and the fastening member 28) in a likewise direction.

From the intermediate position, the cutting insert 22 can be further rotated in the rotational indexing direction R about the pocket indexing axis I until the cutting insert 22 is in a second indexing position. In accordance with some embodiments of the subject matter of the present application, the male-type and female-type engagement members 40, 42 can re-engage with each other. During the re-engagement, the cutting insert 22 is forcibly urged in the biasing direction D_{B} by the ejector member 78 (and thus the fastening member 28) being urged by the biasing member 96. The second insert member flank surfaces 44B can slide over the second pocket member flank surfaces 62B until the first insert member flank surfaces 44A contact the first pocket member flank surfaces 62A. This re-engagement can give the user an indication that the next indexable position has been reached. For example, a ‘clicking’ sound can be produced. The fastening member 28 can then be fastened to adjust the cutting tool 20 to the fastened position. In this non-limiting example shown in the drawings, the fastening member 28 in the form of the clamping screw can be tightened.

It is noted that the cutting tool 20 described above has no falling parts which can be disadvantage when indexing the cutting insert 22.

Although the subject matter of the present application has been described to a certain degree of particularity, it should be understood that various alterations and modifications could be made without departing from the spirit or scope of the invention as hereinafter claimed.

What is claimed is:

1. An insert holder assembly (23) comprising:
an insert holder (24) comprising:
opposite pocket and non-pocket holder side surfaces (52, 54);
an insert receiving pocket (26), having a pocket indexing axis (I) defining a biasing direction (D_{B}), the insert receiving pocket (26) being recessed in the pocket holder side surface (52) and comprising a pocket base surface (56) oriented transversely to the pocket indexing axis (I);
an ejection chamber (64) being forward from the insert receiving pocket (26) in the biasing direction (D_{B}), the ejection chamber (64) comprising a chamber abutment surface (70) and a chamber compression surface (72); and
a holder through hole (74) connecting the ejection chamber (64) and the insert receiving pocket (26), the holder through hole (74) extending along the pocket indexing axis (I);
an ejector member (78) located in the ejection chamber (64), the ejector member (78) comprising an ejector abutment surface (88) and an ejector compression surface (90);
an elastically compressible biasing member (96) elastically compressed between the ejector compression surface (90) and the ejection chamber compression surface (72); wherein:
the insert holder assembly (23) is adjustable between an inner position and an outer position;
in the inner position:
the ejector abutment surface (88) abuts the chamber abutment surface (70);
the ejector compression surface (90) is spaced apart from the chamber compression surface (72) by an inner distance (DI); and
the biasing member (96) exerts an inner compressive force (FI) on the ejector member (78); and
in the outer position:
the ejector abutment surface (88) is spaced apart from the chamber abutment surface (70);
the ejector compression surface (90) is spaced apart from the chamber compression surface (72) by an outer distance (DO), the outer distance (DO) being greater than the inner distance (DI); and
the biasing member (96) exerts an outer compressive force (FO) on the ejector member (78).

2. The insert holder assembly (23), according to claim 1, wherein:
the insert holder (24) comprises:
a holder end surface (50) connecting the pocket and non-pocket holder side surfaces (52, 54); and
a stopper recess (99) recessed in the holder end surface (50) and opening out to the ejection chamber (64); and
the insert holder assembly (23) comprises a stopper member (98) releasably attached to the insert holder (24), the stopper member (98) being located in a stopper recess (99) and projecting into the ejection chamber (64); wherein:
the insert holder assembly (23) is further adjustable to a stop position from the outer position; and
in the stop position:
the stopper member (98) prevents the ejector member (78) from moving in the biasing direction (D_{B});
the ejector compression surface (90) is spaced apart from the chamber compression surface (72) by a stop distance (DS), the stop distance (DS) being greater than the outer distance (DO); and
the biasing member (96) exerts a stop compressive force (FS) on the ejector member (78).

3. The insert holder assembly (23), according to claim 2, wherein:
the ejector member (78) comprises an ejector recess (92) recessed in the ejector peripheral surface (82);
in the stop position:
the stopper member (98) prevents the ejector member (78) from moving in the biasing direction (D_{B}) by being located in the ejector recess (92) and being in contact therewith.

4. The insert holder assembly (23), according to claim 1, wherein:
the ejector member (78) comprises first and second ejector end surfaces (80A, 80B) and an ejector peripheral surface (82) extending therebetween about an ejector central axis (E);
the ejector member (78) comprises a threaded bore (86) which opens out to first ejector end surface (80A).

5. The insert holder assembly (23), according to claim 4, wherein:
the ejector abutment surface (88) is located on the ejector end surface (80A).

6. The insert holder assembly (23), according to claim 5, wherein:
the ejector peripheral surface (82) comprises an ejector shoulder surface (84) oriented transversely to the ejector central axis (E); and
the ejector compression surface (90) is located on the ejector shoulder surface (84).

7. The insert holder assembly (23), according to claim 1, wherein:
the biasing member (96) is a helical spring.

8. The insert holder assembly (23), according to claim 1, wherein:
the holder through hole (74) opens out to the pocket base surface (56).

9. The insert holder assembly (23), according to claim 1, wherein:
the ejection chamber (64) comprises a chamber bottom surface (66);
the holder through hole (74) opens out to the chamber bottom surface (66).

10. The insert holder assembly (23), according to claim 9, wherein:
the chamber abutment surface (70) is formed on the chamber bottom surface (66).

11. The insert holder assembly (23), according to claim 9, wherein:
the chamber compression surface (72) is formed on the chamber bottom surface (66).

12. The insert holder assembly (23), according to claim 1, wherein:
the ejection chamber (64) is recessed in the non-pocket holder side surface (54).

13. The insert holder assembly (23), according to claim 1, wherein:
the insert receiving pocket (26) comprises a pocket peripheral surface (58) oriented transversely to pocket indexing axis (I) and forming a partial boundary of the pocket base surface (56); and
in a view along the pocket indexing axis (I), the pocket peripheral surface (58) defines part of an imaginary pocket circle (PC) having a center contained in the pocket indexing axis (I).

14. The insert holder assembly (23), according to claim 1, wherein:
the pocket base surface (56) comprises a plurality of pocket engagement members (60), the plurality of pocket engagement members (60) comprising a plurality of male-type engagement members (40) or a plurality of female-type engagement members (42).

15. The insert holder assembly (23), according to claim 14, wherein:
the plurality of pocket engagement members (60) comprise the plurality of male-type engagement members (40).

16. The insert holder assembly (23), according to claim 14, wherein:
each pocket engagement member (60) is elongated along a pocket engagement member axis (C), each pocket engagement member (60) comprising two diverging pocket member flank surfaces (62) comprising a first pocket member flank surface (62A) and a second pocket member flank surface (62B) which both extend along the pocket engagement member axis (C).

17. The insert holder assembly (23), according to claim 16, wherein:
the insert receiving pocket (26) has a pocket base plane (P) oriented perpendicular to pocket indexing axis (I) and intersecting the pocket base surface (56);
for any given pocket engagement member (60), in a cross-sectional view taken in a plane oriented perpendicular to the pocket engagement member axis (C):
an outer portion of the first pocket member flank surface (62A) slopes at a first pocket flank angle (α) with respect to the pocket base plane (P);
the second pocket member flank surface (62B) slopes at a second pocket flank angle (β) with respect to the pocket base plane (P); and
the first pocket flank angle (α) is less than the second pocket flank angle (β).

18. The insert holder assembly (23), according to claim 1, wherein:
a fastening member (28) passes through the holder through hole (74) and is attached to the ejector member (78).

19. A cutting tool (20) comprising:
an insert holder assembly (23) in accordance with claim 1;
a cutting insert (22) comprising an insert lower surface (32) and two circumferentially spaced apart cutting edges (36), the cutting insert (22) releasably retained in the insert receiving pocket (26); and
a fastening member (28) passing through the holder through hole (74) and being attached to the ejector member (78); wherein:
the cutting tool (20) is adjustable between a fastened position and a released position; and
in the fastened position:
the insert holder assembly (23) is in the inner position; and
the fastening member (28) rigidly clamps the cutting insert (22) with the insert lower surface (32) abutting the pocket base surface (56);
in the released position:
the insert holder assembly (23) is in the outer position; and
the fastening member (28) clamps the cutting insert (22) with the insert lower surface (32) abutting the pocket base surface (56), by virtue of the fastening member (28) being urged in the biasing direction (D_{B}) by the outer compressive force (FO) applied on the ejector member (78) by the biasing member (96) being elastically compressed.

20. The cutting tool (20), according to claim 19, wherein:
the ejector member (78) comprises a threaded bore (86);
the cutting insert (22) comprises an insert through hole (46); and
the fastening member (28) is a clamping screw threadingly engaged with the threaded bore (86) and located in the insert through hole (46) thereby clampingly engaging the cutting insert (22).

21. The cutting tool (20), according to claim 19, wherein:
the cutting tool (20) is further adjustable to an intermediate position from the released position; and
in the intermediate position:
the insert holder assembly (23) is in the outer position; and
the cutting insert (22) is rotated in a rotational indexing direction (R) about the pocket indexing axis (I) from the released position.

22. The cutting tool (20), according to claim 19, wherein:
the pocket base surface (56) comprises a plurality of pocket engagement members (60);
the insert lower surface (32) comprises a plurality of insert engagement members (38);
one of the plurality of pocket engagement members (60) and the plurality of insert engagement members (38) comprises a plurality of male-type engagement members (40) and the other one of the plurality of pocket engagement members (60) and the plurality of insert engagement members (38) comprises a plurality of female-type engagement member (42); and
in fastened position of the cutting tool (20), the male-type and female-type engagement members (40, 42) inter-engage with each other.

23. The cutting tool (20), according to claim 19, wherein:
the plurality of pocket engagement members (60) comprise the plurality of male-type engagement members (40); and
the plurality of insert engagement members (38) comprise the plurality of female-type engagement members (42).

24. The cutting tool (20), according to claim 19, wherein:
the cutting insert (22) comprises insert upper and lower surfaces (30, 32) and an insert peripheral surface (34) extending therebetween, the insert peripheral surface (34) extending about an insert central axis (A);
in a view along the insert central axis (A):
the at least two cutting edges (36) define an imaginary circumscribed insert circle (IC) having a center contained in the insert central axis (A);
in a view along the pocket indexing axis (I):
the pocket peripheral surface (58) defines an imaginary pocket circle (PC) having a center contained in the pocket indexing axis (I); and
in the fastened position of the cutting tool (20):
in a view along the pocket indexing axis (P), the imaginary circumscribed insert circle (IC) is contained within the imaginary pocket circle (PC).

25. A method for adjusting a cutting tool (20) from a fastened position to a second fastened position; wherein:
the cutting tool (20) is in accordance with claim 21;
the cutting tool (20) is in the fastened position; and
the method includes the steps of:
unfastening the fastening member (26) so that the cutting tool (20) is in the released position;
rotating the cutting insert (22) in the rotational indexing position (R) so that the that the cutting tool (20) is in the intermediate position;
further rotating the cutting insert (22) in the rotational indexing position (R) so that the that the cutting tool (20) is in a second released position; and
fastening the fastening member (26) so that the cutting tool (20) is in a second fastened position.
